(19) United States
(12) Patent Application Publication
(10) Pub. No.: US 2026/0186308 A1
(43) Pub. Date: Jul. 2, 2026

(54) INTERPUPILLARY DISTANCE ADJUSTMENT DEVICE

(71) Applicant: AAC ACOUSTIC TECHNOLOGIES (SHENZHEN) CO., LTD., Shenzhen (CN)

(72) Inventors: Songtao Li, Shenzhen (CN); Qingshan Xu, Shenzhen (CN); Hongyan Tao, Shenzhen (CN)

(21) Appl. No.: 19/336,476

(22) Filed: Sep. 22, 2025

Related U.S. Application Data
(63) Continuation of application No. PCT/CN2024/143919, filed on Dec. 30, 2024.

(51) Int. Cl. G02B 27/01

(52) U.S. Cl. CPC G02B 27/0176; G02B 2027/0154

(57) ABSTRACT

The present application provides an interpupillary distance adjustment device, including a base, a first lens assembly and a second lens assembly that are relatively slidably mounted on the base, a knob rotatably mounted on the base, and a transmission assembly connected to the first lens assembly, the second lens assembly, and the knob. The transmission assembly includes a transmission gear rotatably mounted on the base, and a transmission belt wound around the knob and the transmission gear. The knob is provided with a first groove, and the transmission gear is provided with a second groove. The transmission belt is engaged with the first and second grooves, and the transmission gear is meshed with the first and second lens assemblies. The knob and the drive gear establish a belt-driven mechanism, ensuring smooth rotational force transmission and a superior tactile feedback, and providing a simpler and more reliable structure.

### CROSS-REFERENCE TO RELATED APPLICATIONS

This application is a continuation of International Application No. PCT/CN2024/143919, filed Dec. 30, 2024, the entire contents of which are incorporated herein by reference.

### TECHNICAL FIELD

The present application relates to the technical field of virtual reality equipment, in particular to an interpupillary distance adjustment device.

### BACKGROUND

Currently, the implementation of Virtual Reality (VR) functionality primarily uses VR devices as the carrier, such as head-mounted display devices (VR headsets). A VR headset is a device that utilizes a head-mounted display to isolate the user's vision and hearing from the external environment, inducing a sensation of being present in a virtual environment. The display principle of the head-mounted display is that the left and right screens respectively display left and right images, and the user's binocular vision perceives these differing images, which are then combined in the brain to create a stereoscopic effect.

In the related art, the interpupillary distance adjustment of a VR headset is manually designed, where the distance between the left lens module and the right lens module is adjusted by manually rotating a knob. Specifically, a lead screw-nut mechanism and a gear transmission method are employed for adjustment. The left lens module and the right lens module are engaged with a rotating shaft, a transition gear is engaged with the rotating shaft, and the knob is engaged with the transition gear. The transition gear is a helical gear. However, since the transition gear has a relatively large helix angle, the rotational force is uneven when turning the knob, resulting in poor tactile feedback.

Therefore, it is necessary to provide a new interpupillary distance adjustment device.

### SUMMARY

An object of the present application is to provide an interpupillary distance adjustment device capable of addressing the technical issue of uneven rotational force when rotating the knob of the interpupillary distance adjustment device in the related art.

The technical solution of the present application is as follows:

An interpupillary distance adjustment device, including:
a base;
a first lens assembly and a second lens assembly that are relatively slidably mounted on the base;
a knob rotatably mounted on the base; and
a transmission assembly connected to the first lens assembly, the second lens assembly and the knob, wherein the transmission assembly includes a transmission gear rotatably mounted on the base, and a transmission belt, opposite ends of which are wound around the knob and the transmission gear, respectively; the knob is provided with a first groove, and the transmission gear is provided with a second groove; the transmission belt is engaged with the first groove and the second groove, and the transmission gear is meshed with the first lens assembly and the second lens assembly.

As an improvement, the base is provided with a first protrusion, and the knob is provided with a first mounting hole; the first protrusion is mounted in the first mounting hole, the knob rotates around the first protrusion and drives the transmission belt to rotate synchronously, and the transmission gear rotates synchronously with the transmission belt.

As an improvement, the interpupillary distance adjustment device further includes a limiting assembly fixed to an end of the first protrusion away from the base, wherein two ends of the knob are abutted against the limiting assembly and the base, respectively.

As an improvement, the limiting assembly includes a limiting member fixed to the first protrusion, a support plate disposed at an end of the limiting member close to the base, and a protective plate abutted against the support plate and the knob, wherein the support plate has elasticity in a direction parallel to a direction of the first protrusion.

As an improvement, the first lens assembly includes a first slider slidably mounted on the base and provided with a first meshing gear, and a first lens module connected to the first slider, wherein the first meshing gear is meshed with the transmission gear;
the second lens assembly includes a second slider slidably mounted on the base and provided with a second meshing gear, and a second lens module connected to the second slider, wherein the second meshing gear is meshed with the transmission gear;
the first slider and the second slider are configured to slide relative to each other, and the first meshing gear and the second meshing gear are disposed on opposite sides of the transmission gear, respectively.

As an improvement, the first meshing gear is arranged directly opposite the transmission gear, and the second meshing gear is arranged directly opposite the transmission gear.

As an improvement, the first slider is provided with a third groove, and the first lens module is provided with a first snap-fit portion engaged with the third groove;
the second slider is provided with a fourth groove, and the second lens module is provided with a second snap-fit portion engaged with the fourth groove.

As an improvement, the interpupillary distance adjustment device further includes a first guide shaft fixed to the base, wherein the first slider and the second slider are relatively slidably mounted on the first guide shaft.

As an improvement, the first slider includes a sliding portion slidably mounted on the base and connected to the first lens module, a connecting portion fixed to the sliding portion, and a meshing portion fixed to an end of the connecting portion away from the sliding portion; the meshing portion is provided with the first meshing gear, and the meshing portion and the second slider are respectively disposed on opposite sides of the transmission gear and are parallel to each other.

As an improvement, the interpupillary distance adjustment device further includes a second guide shaft fixed to the base and parallel to the first guide shaft, wherein the first lens module and the second lens module are relatively slidably mounted on the second guide shaft.

The beneficial effects of the present application are as follows: the knob and drive gear are connected via a transmission belt, establishing a belt-driven mechanism between them. This configuration ensures smooth rotational force transmission during knob operation, resulting in superior tactile feedback. Furthermore, compared to conventional lead screw-nut systems and gear-driven adjustment mechanisms, the knob and the transmission gear are connected via the transmission belt, and the transmission gear is meshed with the first lens assembly and the second lens assembly, thereby providing a simpler and more reliable structure.

### BRIEF DESCRIPTION OF THE DRAWINGS

FIG. 1 is a schematic diagram of an overall structure of an interpupillary distance adjustment device according to an embodiment of the present application.

FIG. 2 is a schematic structural diagram of the interpupillary distance adjustment device after removing the second lens module according to an embodiment of the present application.

FIG. 3 is an enlarged view of detail A in FIG. 2.

FIG. 4 is an assembly schematic diagram of a base, a first guide shaft, and a second guide shaft according to an embodiment of the present application.

FIG. 5 is an assembly schematic diagram of a knob and a limiting assembly according to an embodiment of the present application.

FIG. 6 is a cross-sectional view taken along the B-B direction in FIG. 5.

FIG. 7 is a structural schematic diagram of a transmission gear according to an embodiment of the present application.

FIG. 8 is a structural schematic diagram of a second lens module according to an embodiment of the present application.

FIG. 9 is a structural schematic diagram of a first slider according to an embodiment of the present application.

### DETAILED DESCRIPTION OF THE EMBODIMENTS

The present application will be described in further detail with reference to the accompanying drawings and embodiments.

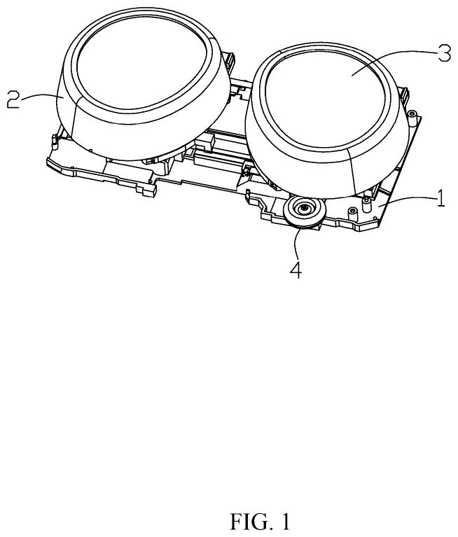

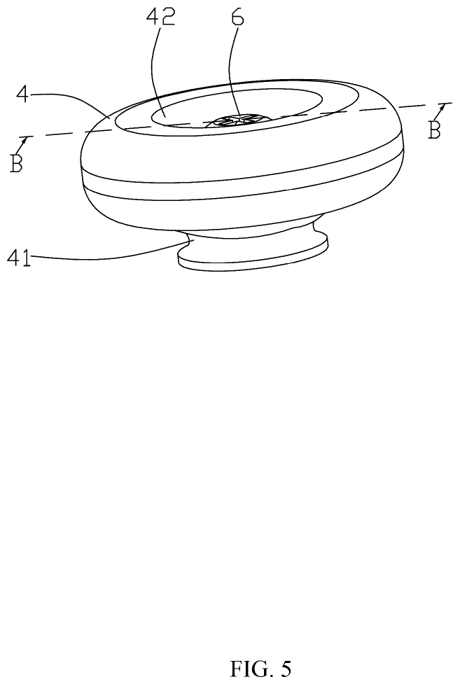

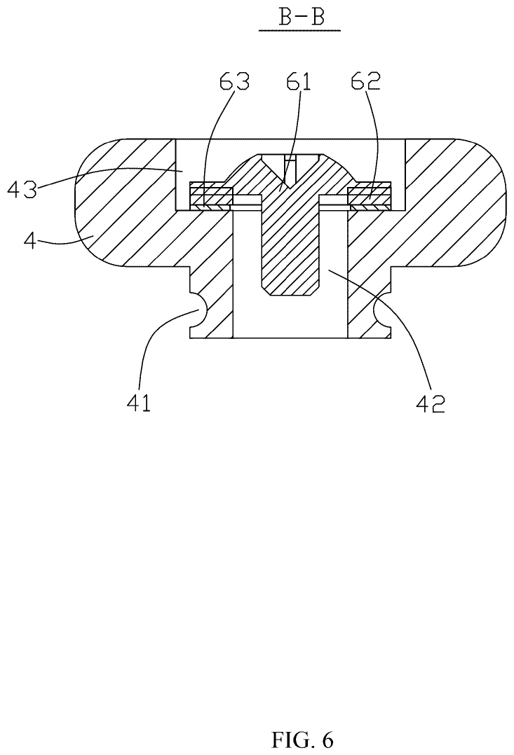

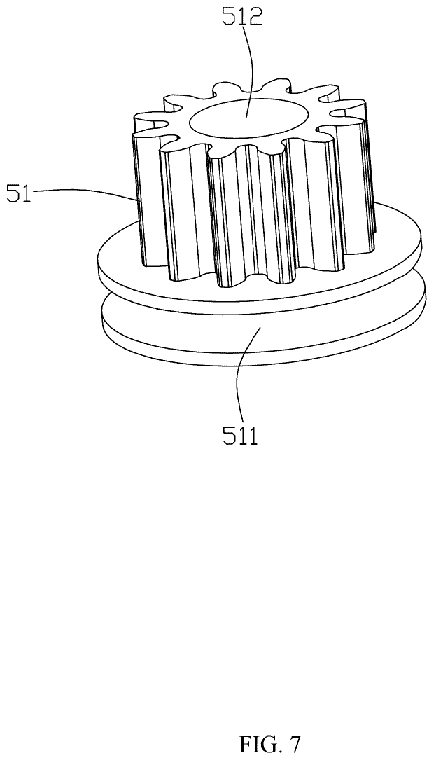

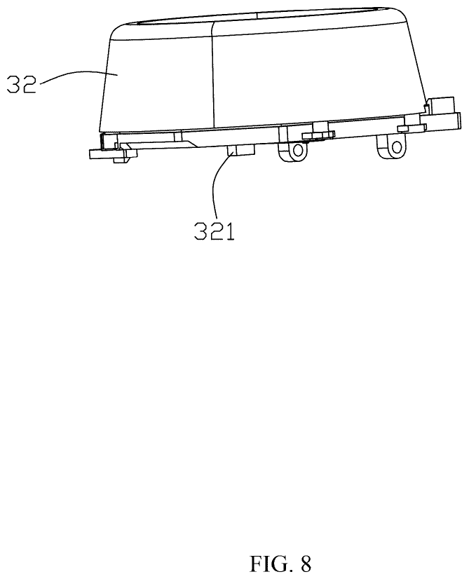

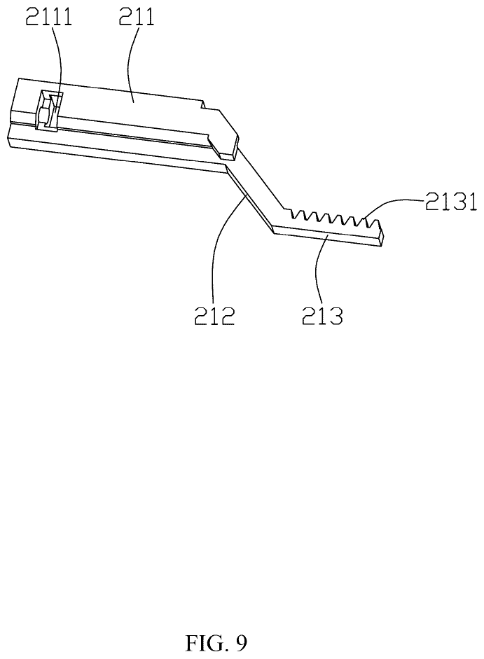

As shown in FIGS. 1 to 9, the present application provides an interpupillary distance adjustment device applicable to VR headsets (e.g., VR glasses). The interpupillary distance adjustment device includes a base 1, a first lens assembly 2 and a second lens assembly 3 that are relatively slidably mounted on the base 1, a rotatable knob 4 mounted on the base 1, and a transmission assembly 5 connected to the first lens assembly 2, the second lens assembly 3 and the knob 4. The transmission assembly 5 includes a transmission gear 51 rotatably mounted on the base 1, and a transmission belt 52 wound around the knob 4 and the transmission gear 51 at opposite ends, respectively. The knob 4 is provided with a first groove 41, and the transmission gear 51 is provided with a second groove 511. The transmission belt 52 is engaged with the first groove 41 and the second groove 511, and the transmission gear 51k is meshed with the first lens assembly 2 and the second lens assembly 3.

Since the knob 4 and the transmission gear 51 are connected via the transmission belt 52, establishing a belt-driven mechanism between the knob 4 and the transmission gear 51. This configuration ensures smooth rotational force transmission during rotating the knob 4, resulting in superior tactile feedback. Furthermore, compared to conventional lead screw-nut systems and gear-driven adjustment mechanisms, the knob 4 and the transmission gear 51 are connected via the transmission belt 52, and the transmission gear 51 is meshed with the first lens assembly 2 and the second lens assembly 3, thereby providing a simpler and more reliable structure.

It should be noted that the first groove 41 and the second groove 511 are recessed in a semicircular shape toward a center axis of the knob 4 and a center axis of the transmission gear 51, respectively. The cross-section of the transmission belt 52 is circular, and the transmission belt 52 is engaged with the first groove 41 and the second groove 511. In other embodiments, the first groove 41, the second groove 511, and the transmission belt 52 may also adopt other forms of interlocking engagement.

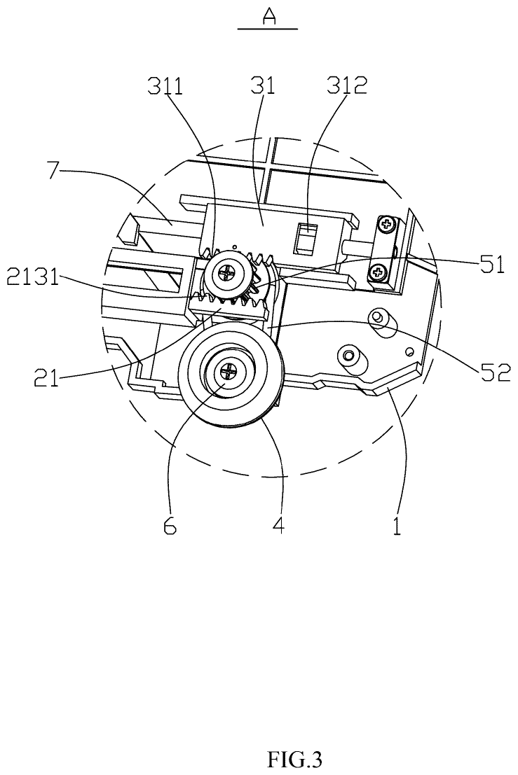

As shown in FIGS. 3, 4, and 5, the base 1 is provided with a first protrusion 11, and the knob 4 is provided with a first mounting hole 42. The first protrusion 11 is inserted into the first mounting hole 42, and the knob 4 rotates around the first protrusion 11, achieving a rotational connection between the knob 4 and the base 1. The knob 4 drives the transmission belt 52 to rotate synchronously. The transmission gear 51 rotates synchronously with the transmission belt 52, achieving static friction transmission between the transmission belt 52 and the knob 4, as well as between the transmission belt 52 and the transmission gear 51. Therefore, the rotational smoothness between the transmission belt 52 and the knob 4 as well as between the transmission belt 52 and the transmission gear 51 is improved, thereby enhancing the rotational tactile feel of the knob 4.

According to actual needs, the first protrusion 11 may be cylindrical, the first protrusion 11 is perpendicular to the surface of the base 1, and the knob 4 is sleeved around the outer surface of the first protrusion 11.

As shown in FIGS. 3, 4, and 7, the base 1 is further provided with a second protrusion 12. The transmission gear 51 is provided with a second mounting hole 512, and the second protrusion 12 is mounted within the second mounting hole 512. The transmission gear 51 rotates around the second protrusion 12, thereby achieving a rotational connection between the transmission gear 51 and the base 1. According to actual needs, the second protrusion 12 may be cylindrical, and the second protrusion 12 is perpendicular to the plate surface of the base 1. The transmission gear 51 is sleeved around the outer surface of the second protrusion 12, and the transmission gear 51 is secured to the base 1 by a screw with a nut. The screw is connected to an end of the second protrusion 12 away from the base 1, and the nut of the screw contacts an end face of the transmission gear 51 away from the base 1.

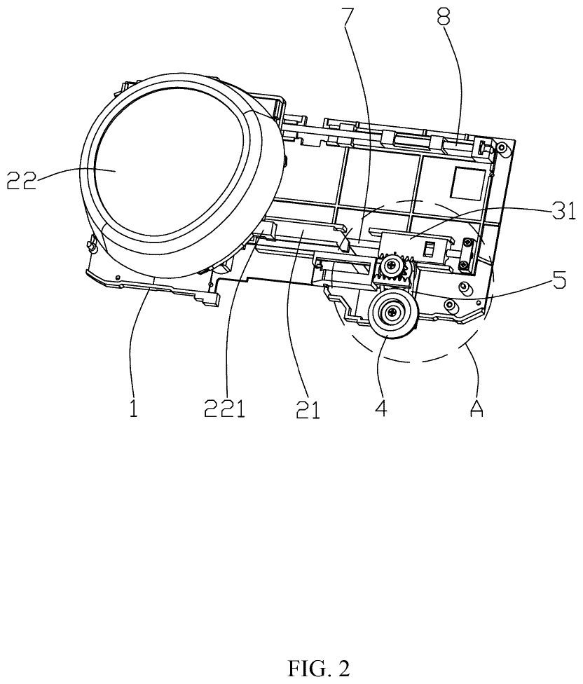

As shown in FIGS. 2, 3, and 5, the interpupillary distance adjustment device further includes a limiting assembly 6 fixed to an end of the first protrusion 11 away from the base 1. The two ends of the knob 4 abut against the limiting assembly 6 and the base 1, respectively, such that the limiting assembly 6 prevents the knob 4 from disengaging from the base 1 along the length of the first protrusion 11, thereby restricting the knob 4 to the base 1.

As shown in FIGS. 3, 4, and 6, the limiting component 6 includes a limiting member 61 fixed to the first protrusion 11, a support plate 62 disposed at an end of the limiting member 61 close to the base 1, and a protective plate 63 that abuts against both the support plate 62 and the knob 4. The limiting member 61 restricts the knob 4 to the base 1 via the support plate 62 and the protective plate 63. The support plate 62 has elasticity in the direction parallel to a direction of the first protrusion 11, so that the support plate 62 can make the contact between the knob 4 and the base 1, as well as between the knob 4 and the limiting member 61, more secure, thereby preventing the knob 4 from shaking and increasing the resistance felt when rotating the knob 4. The protective plate 63 prevents the support plate 62 from scratching the knob 4. Depending on actual requirements, the limiting member 61 may be a screw with a nut, and the screw is installed at the end of the first protrusion 11 away from the base 1. The support plate 62 may be a wave washer, and the protective plate 63 may be a standard washer.

As shown in FIGS. 3, 4, and 6, in some embodiments, both the support plate 62 and the protective plate 63 are mounted on the outer side of the first protrusion 11. The knob 4 has a mounting slot 43 connected to the first mounting hole 42, and the limiting assembly 6 is accommodated within the mounting slot 43, i.e., the limiting member 61, the support plate 62, and the protective plate 63 are all located within the mounting slot 43. The first protrusion 11 is configured to protrude relative to the bottom wall of the mounting slot 43, which not only facilitates mounting the support plate 62 and protective plate 63 on the outer side of the first protrusion 11 but also reduces the protrusion height of the first protrusion 11.

As shown in FIGS. 1, 2, and 3, the first lens assembly 2 includes a first slider 21 slidably mounted on the base 1 and provided with a first meshing gear 2131, and a first lens module 22 connected to the first slider 21. The first meshing gear 2131 is meshed with the transmission gear 51, enabling the transmission gear 51 to drive the first slider 21 to move, and the first slider 21 drives the first lens module 22 to move. The second lens assembly 3 includes a second slide 31 slidably mounted on the base 1 and provided with a second meshing gear 311, and a second lens module 32 connected to the second slide 31. The second meshing gear 311 is meshed with the transmission gear 51, enabling the transmission gear 51 to drive the second slide 31 to move, and the second slider 31 drives the second lens module 32 to move. The first slider 21 and the second slider 31 are configured to slide relative to each other, and the first meshing gear 2131 and the second meshing gear 311 are respectively disposed on opposite sides of the transmission gear 51, enabling the transmission gear 51 to drive the first slider 21 and the second slider 31 to move toward each other or in opposite directions, thereby driving the first lens module 22 and the second lens module 32 to move toward each other or in opposite directions, achieving adjustment of the interpupillary distance.

It should be noted that when the knob 4 is turned clockwise, the first lens module 22 and the second lens module 32 move in opposite directions, specifically, the first lens module 22 moves to the left and the second lens module 32 moves to the right, thereby increasing the interpupillary distance. When the knob 4 is rotated counterclockwise, the first lens module 22 and the second lens module 32 move toward each other, specifically, the first lens module 22 moves to the right and the second lens module 32 moves to the left, thereby reducing the interpupillary distance.

As shown in FIGS. 2 and 3, in some embodiments, the first meshing gear 2131 is arranged oppositely the transmission gear 51, and the second meshing gear 311 is arranged oppositely the transmission gear 51, such that the first meshing gear 2131 and the transmission gear 51, as well as the second meshing gear 311 and the transmission gear 51, are both straight-tooth meshing rather than helical-tooth meshing, thereby enhancing the stability of the transmission and further improving the rotational feel of the knob 4.

As shown in FIGS. 2, 3, and 9, the first slider 21 is provided with a third groove 2111, and the first lens module 22 is provided with a first snap-fit portion 221 that engages with the third groove 2111. The first snap-fit portion 221 and the third groove 2111 engage with each other to achieve a fixed connection between the first lens module 22 and the first slider 21. The second slider 31 is equipped with a fourth groove 312, and the second lens module 32 is equipped with a second snap-fit portion 321 that engages with the fourth groove 312. The second snap-fit portion 321 and the fourth groove 312 engage with each other to achieve a fixed connection between the second lens module 32 and the second slider 31. According to actual needs, the third groove 2111 is located at the end of the first slider 21 away from the second slider 31, and the fourth groove 312 is located at the end of the second slider 31 away from the first slider 21.

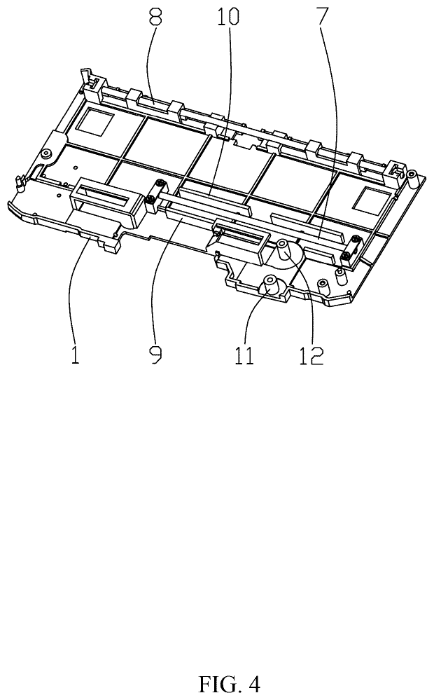

As shown in FIGS. 2 and 4, the interpupillary distance adjustment device further includes a first guide shaft 7 fixed to the base 1. The first slider 21 and the second slider 31 are slidably mounted on the first guide shaft 7, i.e., the first slider 21 and the second slider 31 are coaxially arranged, enabling the first guide shaft 7 to guide the movement of the first slider 21 and the second slider 31, thereby improving the smoothness of movement of the first lens module 22 and the second lens module 32.

As shown in FIGS. 2, 3, and 9, the first slider 21 includes a sliding portion 211 that is slidably mounted on the base 1 and connected to the first lens module 22, a connecting portion 212 fixed to the sliding portion 211, and an engagement portion 213 fixed to the end of the connecting portion 212 away from the sliding portion 211. The engagement section 213 is provided with a first engagement tooth 2131. The engagement section 213 and the second slider 31 are respectively disposed on opposite sides of the transmission gear 51 and are parallel to each other, enabling the transmission gear 51 to drive the first slider 21 and the second slider 31, which are coaxially disposed, to move toward each other or in opposite directions. As needed, the third groove 2111 may be provided on the sliding portion 211, which is coaxially arranged with the second sliding rail 31, and the sliding portion 211 and the meshing portion 213 are parallel to each other.

As shown in FIGS. 2 and 4, the interpupillary distance adjustment device further includes a second guide shaft 8 fixed to the base 1 and parallel to the first guide shaft 7. The first lens module 22 and the second lens module 32 are relatively slidably arranged on the second guide shaft 8, thereby improving the smoothness of movement of the first lens module 22 and the second lens module 32.

As shown in FIGS. 2 and 4, the base 1 further includes a first limiting plate 9 and a second limiting plate 10. The first limiting plate 9 and the second limiting plate 10 are respectively positioned on opposite sides of the first guide shaft 7. The first slider 21 and the second slider 31 are both located between the first limiting plate 9 and the second limiting plate 10, thereby preventing the first slider 21 and the second slider 31 from rotating relative to the first guide shaft 7.

Described above are only embodiments of the present application, and it should be pointed out that, for the ordinary technical personnel in the field, improvements may also be made without departing from the premise of the concept of the present application, but these are all within the protection scope of the present application.

What is claimed is:

1. An interpupillary distance adjustment device, comprising:
a base;
a first lens assembly and a second lens assembly that are relatively slidably mounted on the base;
a knob rotatably mounted on the base; and
a transmission assembly connected to the first lens assembly, the second lens assembly and the knob, wherein the transmission assembly comprises a transmission gear rotatably mounted on the base, and a transmission belt, opposite ends of which are wound around the knob and the transmission gear, respectively; the knob is provided with a first groove, and the transmission gear is provided with a second groove; the transmission belt is engaged with the first groove and the second groove, and the transmission gear is meshed with the first lens assembly and the second lens assembly.

2. The interpupillary distance adjustment device of claim 1, wherein the base is provided with a first protrusion, and the knob is provided with a first mounting hole; the first protrusion is mounted in the first mounting hole, the knob rotates around the first protrusion and drives the transmission belt to rotate synchronously, and the transmission gear rotates synchronously with the transmission belt.

3. The interpupillary distance adjustment device of claim 2, further comprising a limiting assembly fixed to an end of the first protrusion away from the base, wherein two ends of the knob are abutted against the limiting assembly and the base, respectively.

4. The interpupillary distance adjustment device of claim 3, wherein the limiting assembly comprises a limiting member fixed to the first protrusion, a support plate disposed at an end of the limiting member close to the base, and a protective plate abutted against the support plate and the knob, wherein the support plate has elasticity in a direction parallel to a length of the first protrusion.

5. The interpupillary distance adjustment device of claim 1, wherein the first lens assembly comprises a first slider slidably mounted on the base and provided with a first meshing gear, and a first lens module connected to the first slider, wherein the first meshing gear is meshed with the transmission gear;
the second lens assembly comprises a second slider slidably mounted on the base and provided with a second meshing gear, and a second lens module connected to the second slider, wherein the second meshing gear is meshed with the transmission gear;
the first slider and the second slider are configured to slide relative to each other, and the first meshing gear and the second meshing gear are disposed on opposite sides of the transmission gear, respectively.

6. The interpupillary distance adjustment device of claim 5, wherein the first meshing gear is arranged directly opposite the transmission gear, and the second meshing gear is arranged directly opposite the transmission gear.

7. The interpupillary distance adjustment device of claim 5, wherein the first slider is provided with a third groove, and the first lens module is provided with a first snap-fit portion engaged with the third groove;
the second slider is provided with a fourth groove, and the second lens module is provided with a second snap-fit portion engaged with the fourth groove.

8. The interpupillary distance adjustment device of claim 5, further comprising a first guide shaft fixed to the base, wherein the first slider and the second slider are relatively slidably mounted on the first guide shaft.

9. The interpupillary distance adjustment device of claim 8, wherein the first slider comprises a sliding portion slidably mounted on the base and connected to the first lens module, a connecting portion fixed to the sliding portion, and a meshing portion fixed to an end of the connecting portion away from the sliding portion; the meshing portion is provided with the first meshing gear, and the meshing portion and the second slider are respectively disposed on opposite sides of the transmission gear and are parallel to each other.

10. The interpupillary distance adjustment device of claim 9, further comprising a second guide shaft fixed to the base and parallel to the first guide shaft, wherein the first lens module and the second lens module are relatively slidably mounted on the second guide shaft.
